(19) United States
(12) Patent Application Publication
(10) Pub. No.: US 2005/0288919 A1
(43) Pub. Date: Dec. 29, 2005

(54) Method and system for model-parameter machine translation

(76) Inventor: Jian Chun Wang, North Potomac, MD (US)

Correspondence Address: Jian Chun Wang, 14001 Saddle River Dr, North Potomac, MD, 20878, US

(21) Appl. No.: 10/878,069

(22) Filed: Jun. 28, 2004

(51) Int. Cl. G06F 17/28

(52) U.S. Cl. 704/2

(57) ABSTRACT

An invention of the model-parameter machine translation is developed for use in language translation. This invention combines certain sentence express model that is unchangeable and the vocabulary parameter within the sentence express model is changeable by user's request. Therefore, it can dispel the ambiguity in different interpretation for a word, which is a most difficult problem for machine translation. Since the sentence express model is extracted from a sentence of a natural language, a result of the translation still keeps the accuracy, the fluency and the intact characteristic of the natural language in the translated sentence. User does not need to have other language knowledge when he/she wants to use this model-parameter machine translation system. This translation system is highly efficient, accurate, fast and convenient.

### BACKGROUND OF THE INVENTION

Machine translation between different languages is a science and an art. Machine translation made very great progresses during the pass decades as people's auxiliary translation tool. It is suitable for regularly structured sentences but not for the chaotic natural use of language. Because of the multiple meanings of a word, machine translation is often an inaccurate translation system. This issue is a heavy obstacle for the development of machine translation. A large amount of energies has been devoted to research on machine translation. However, a practical, flexible and high-quality automatic translation system has still not appeared. This has proved a huge difficulty for developing a perfect language translation system. The existing translation software can be divided into three different fields:

The first type is an electronic dictionary. It carries the interpreted meaning of vocabulary. When the users met new words of a foreign language during the reading, the meaning of the word is outputted. But this type of the translation is very limited in it's accuracy and ability to decipher complicated documents.

The second type is full text translation. It translates a whole article from a language to another language. This type translation converts sentences' meanings between languages based on use of dictionary and grammar rules. Because of the complexity of the language and the limitation of the current technology of machine translation, the result of the full text translation is rarely satisfactorily.

The third type is computer auxiliary interpreter CAT's (Computer Aided Translation) based on a human-computer interaction and a translation memory technology. It only plays an auxiliary role, and the most of the translating process still needs to be done by a human. This technique can improve the efficiency and the accuracy of the translation. However, the computing auxiliary interpreter only does pre-translating, and the bulk of the work still requires a human.

Three types of translation methods all have obvious shortcomings. The development of machine translation is in a state of a bottleneck. If machine translation needs to be as fluent as artificial translation, many years of research needs to be done. Opening up a new approach should be the future goal of machine translation.

### SUMMARY OF THE INVENTION

The purpose of invention is offering a computer automatic translation system, which has an accurate, intact meaning for the translation of the natural language. User can use this translation utility without having any knowledge of other languages; which are translated as target languages. This translation system is high efficient, accurate, fast and convenient for the translation processing. It can be used between various kinds of the languages as a translating process system. The basic principle of the model-parameter machine translation is: Utilizing the specific professional field, specific occasion and specific service condition to limit the expression ways of the natural language into single or several kinds of specific expression patterns. Under this principle, the multiple meaning of a vocabulary can be limited into a single meaning expression. Ambiguous meanings of vocabulary can be avoided in the translating process.

According to the above-mentioned model parameter of machine translation, the frame of a client-network-translating server and a stand along type are used. In the frame of a client-network-translating server, the input of a language translation is processed on the client side, and the translating processes are done at the translating server. The input and output of the language translation between two languages are communicated through the network system between the client and the translating server. By the client's request, the translating server can send the results of the translation one or more than one clients.

The method of a model-parameter machine translation is: By using the specific fields, the specific occasions, the specific purposes, the specific applications and the specific conditions to make up the specific factors for machine translation's using. Base on these specific factors, one or more than one specific models from a special meaning at natural language will be set up for machine translation. A primitive text sentence express model is a sentence express pattern that is set up from the specific factors at an original language. A translate text sentence express model is a translated sentence express pattern, which corresponds to the primitive text sentence express model at the target language. Both the primitive text sentence express model and the translate text sentence express model are stored in the translating server and correspond to each other. Either in the primitive text sentence express model or in the translate text sentence express model, every word can be a unit parameter for change according to the translating process's needs. The unit word is called a “vocabulary parameter”.

At the client side in the frame of a client-network-translating server, user can choose a primitive text sentence express model through a interface of a monitor by using a mouse or a keyboard according to their needs; next, user choose a vocabulary parameter by using the mouse or the keyboard from primitive text sentence express model that is chosen. User can change the value of the vocabulary parameter in order to avoid ambiguous emergences at the meaning of the vocabulary. At the server side, the translating server will automatically integrates the translate text sentence express model that corresponded with the primitive text sentence express model that is chosen by user and the value of the vocabulary that has been translated and corresponded to the input of vocabulary parameter at the primitive text sentence express model to make a translated intact sentence and outputs the translating result to the interface of monitor on the client side.

According to the primitive text sentence express model include the vocabulary parameter or not, the primitive text sentence express model is divided into the non-parameter primitive text sentence express model and the parameter primitive text sentence express model. Corresponding with the primitive text sentence express model, the translate text sentence express model also is divided into the non-parameter translate text sentence express model and the parameter translate text sentence express model.

In the model-parameter machine translation system, a sentence, which has a special meaning in the natural language, can be expressed from more than one kind of the primitive text sentence express models according to the user's selection. User can choose a primitive text sentence express model and input or select value(s) of the vocabulary parameter(s) from the primitive text sentence express model by using the mouse or the keyboard according to their needs. When the vocabulary parameter is selected and sent to the server side, the translating server automatically checks on the rule of the grammar to make sure the grammar expression of the translated vocabulary, which corresponded to the input of vocabulary parameter is consistent with the rule of the grammar at the translate text sentence express model. If the translating server find any inconsistency between the vocabulary parameter and the translate text sentence express model, it automatically revises the inconsistent part at the translated vocabulary base according to the rule of the grammar expression of the translate text sentence express model. Thus making both parts unanimous. When the translated vocabularies are multiple, the translating server checks the grammar and revises the inconsistency with the grammar rule from the far left of the word unit to last one of the word unit at the translate text sentence express model.

User can choose a pattern of the translation from one language as an original language to another language as a target language through the interface of the monitor by using the mouse or the keyboard at the client side. The interface of the monitor automatically provides the professional field catalogue. The professional field catalogue consists of a title list of the stylebooks, which are articles for different purpose's using. A title can be chosen from the title list for a translation by user's selection, and then, the interface of the monitor will automatically displays the content of that stylebook.

The stylebook is consisting of more than one lists of the primitive text sentence express model. The list of the primitive text sentence express model is consist of the primitive text sentence express models, which they have similar meaning for a specific semantic sentence. User can select the primitive text sentence express model from the list for what they need. If a primitive text sentence express model is chosen from the list, the translating server will automatically displays the primitive text sentence express model and the prompt(s) of the vocabulary parameter(s) through the interface of the monitor. User can input or select the value of the vocabulary parameter at the prompt by using the mouse or keyboard. If the user does not choose the primitive text sentence express model from the list, the translating server automatically displays the first primitive text sentence express model from the list. The first primitive text sentence express model is always the non-parameter primitive text sentence express model. The selected primitive text sentence express model and the inputted and selected value of the vocabulary parameter are sent to the translating server.

The translating server receives the information of the primitive text sentence express model and the value of the vocabulary parameter from the client side, and then it inspects if the translate text sentence express model, which corresponds to the primitive text sentence express model exists or not; If the result of the inspection showed a consistency between the primitive text sentence express model and the translate text sentence express model, the translating server will inspects if the primitive text sentence express model is the non-parameter primitive text sentence express model or not; If the answer is yes, then the translating server automatically sends back the result of the translation to the client side and displays the result through the interface of the monitor. Otherwise, the translating server automatically evaluates if the inputting value of the vocabulary parameter matches the value of the translated vocabulary, which has been translated as the target language; If matched, the result of the translation is formed from the translate text sentence express model and the value of the translated vocabulary. The translating server automatically sends back the result of the translation to the client side and displays the result through the interface of the monitor.

According to model-parameter machine translation system, the meaning of the network includes Internet, WAN, LAN, telephone wire network, optical cable network, wireless network and the combinations of those networks.

According to model-parameter machine translation system, the translating server includes the central processing unit, memory, display utilities, keyboard and mouse.

According to model-parameter machine translation system, the memories are divided into the display utility memory, the translate text sentence express model's memory, the primitive text sentence express model's memory and processing memory.

This invention combined the sentence express model that is unchangeable and the vocabulary parameter that is changeable by user's request at the sentence express model. Therefore, it can dispel the ambiguity in different interpretation for one word, which is a most difficult problem for machine translation. Since the sentence express model is extracted from the sentence of a natural language, the rules of the grammar in the sentence of the natural language are still imbedded in the sentence express model. Therefore the result of the translation still keeps the accuracy, the fluency and the intact characteristic of the natural language in the translated sentence. Computer automatically does all of the translating processes; user does not need to have other language knowledge when he/she wants to use this model-parameter machine translation system. This translation system is highly efficient, accurate, fast and convenient. This invention also has the following advantages: 1, this translation system does not need to have expensive equipments. 2, use of the system is not complicated: user can use the mouse or the keyboard to handle the translating processes. 3, the data of the translated result can be stored for reuse.

### BRIEF DESCRIPTION OF THE DRAWINGS

FIG. 1 is a diagram of the model-parameter machine translation for the client-network-translating server system.

FIG. 2 is a diagram of the model-parameter machine translation for the stand-alone computer.

FIG. 3 is a process flow chart of the client side in the model-parameter machine translation system.

FIG. 4 is a process flow chart of the translating server side in the model-parameter machine translation system.

FIG. 5 is the first screenshot window of Chinese-English translating model.

FIG. 6 is the second screenshot window of Chinese-English translating model.

FIG. 7 is the third screenshot window of Chinese-English translating model.

FIG. 8 is a screenshot window of the translating result of Chinese-English translating model.

FIG. 9 is the first screenshot window of English-Chinese translating model.

FIG. 10 is the second screenshot window of English-Chinese translating model.

FIG. 11 is the third screenshot window of English-Chinese translating model.

FIG. 12 is a screenshot window of the translating result of English-Chinese translating model.

### DETAILED DESCRIPTION OF PREFERRED EMBODIMENT

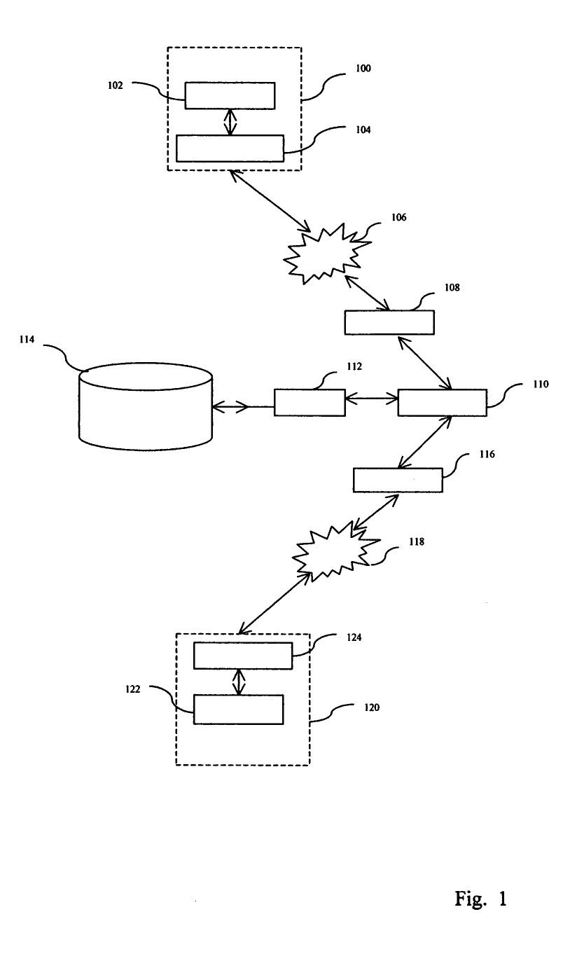

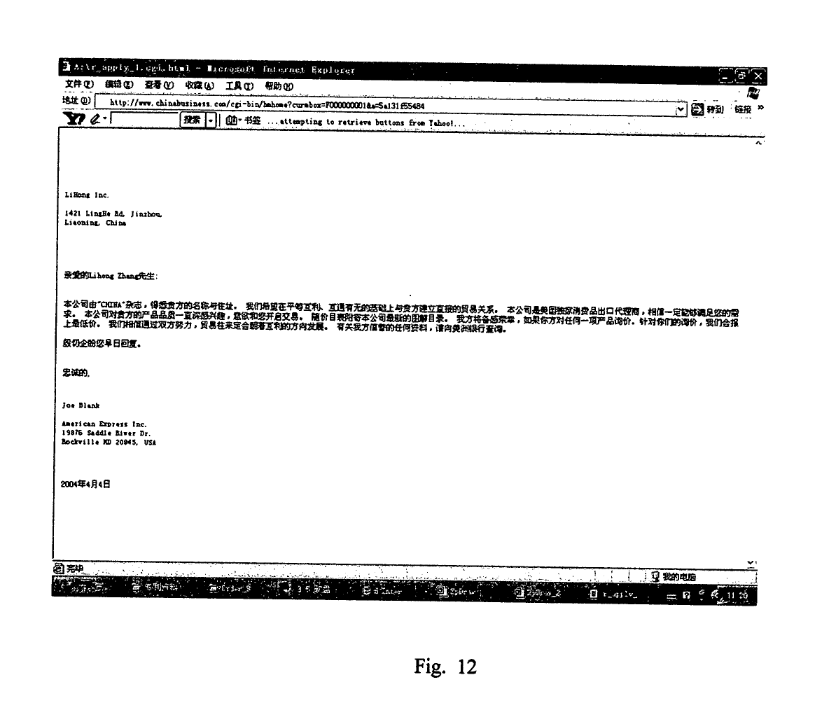

FIG. 1-FIG. 12 are intended as an example, and not as a limitation for the purpose of the present invention.

The model-parameter machine translation: By using the specific fields, the specific occasions, the specific purposes, the specific applications and the specific conditions that make up the specific factors for machine translation's use, one or more than one specific models from a special meaning at natural language will be set up for machine translation.

A primitive text sentence express model is a sentence express pattern that set out from the specific factors at an original language. A translate text sentence express model is a translated sentence express pattern, which corresponds to the primitive text sentence express model at a target language. Both the primitive text sentence express model and the translate text sentence express model are stored in the translating server and correspond to each other. Either in the primitive text sentence express model or in the translate text sentence express model, every word can be changed as a unit by a translating process' needs. A word unit is called a “vocabulary parameter”. At the client side in the frame of a client-network-translating server, users can choose a primitive text sentence express model through an interface of a monitor by using a mouse or a keyboard according to their needs; next, users choose a vocabulary parameter by using the mouse or the keyboard from primitive text sentence express model that is chosen. User can change the value of the vocabulary parameter in order to avoid ambiguous emergences at the meaning of the vocabulary. At the server side, the translating server will automatically integrates the translate text sentence express model that corresponded with the primitive text sentence express model that is chosen by user and the value of the vocabulary that has been translated and corresponded to the input of vocabulary parameter at the primitive text sentence express model to make a translated intact sentence and outputs the translated result to the interface of monitor on the client side. According to if the primitive text sentence express model include the vocabulary parameter or not, the primitive text sentence express model is divided to the non-parameter primitive text sentence express model and the parameter primitive text sentence express model. Corresponding with the primitive text sentence express model, the translate text sentence express model also is divided to the non-parameter translate text sentence express model and the parameter translate text sentence express model.

In model-parameter machine translation system, a sentence, which has a special meaning at the natural language can be expressed from more than one kind of the primitive text sentence express models for user's selection. Users can choose a primitive text sentence express model and input or select value(s) of the vocabulary parameter(s) from the primitive text sentence express model by using the mouse or the keyboard according to their needs. When the vocabulary parameter is selected and sent to the server side, the translating server automatically checks on the rule of the grammar to make sure the grammar expression of the translated vocabulary, which corresponded to the input of vocabulary parameter, is consistent with the rule of the grammar at the translate text sentence express model. If the translating server find inconsistency between the vocabulary parameter and the translate text sentence express model, it automatically revises the inconsistent part at the translated vocabulary base on the rule of the grammar expression of the translate text sentence express model to make both parts unanimous. When the translated vocabularies are multiple, the translating server checks the grammar and revises the inconsistency with the grammar rule from the far left of the vocabulary to the last of the vocabulary at the translate text sentence express model. Users can choose a pattern of the translation from one language as an original language to another language as a target language through the interface of the monitor by using the mouse or the keyboard at the client side. The interface of the monitor automatically provides the professional field catalogue. The professional field catalogue consists of a title list of the stylebooks, which are article for different purposes. A title can be chosen from the title list for a translation by user's selection, and then, the interface of the monitor will automatically displays the content of that stylebook. The stylebook consists of more than one lists of the primitive text sentence express model. The list of the primitive text sentence express model consists of the primitive text sentence express models, which have similar meaning for a specific semantic sentence. Users can select the primitive text sentence express model from the list for what they need. If a primitive text sentence express model is chosen from the list, the translating server will automatically displays the primitive text sentence express model and the prompt(s) of the vocabulary parameter(s) through the interface of the monitor. User can input or select the value of the vocabulary parameter at the prompt by using the mouse or keyboard. If users do not choose the primitive text sentence express model from the list, the translating server automatically displays the first primitive text sentence express model from the list through the interface of the monitor. The first primitive text sentence express model always is the non-parameter primitive text sentence express model. The selected primitive text sentence express model and the inputted and selected value of the vocabulary parameter are sent to the translating server.

The translating server receives the information of the primitive text sentence express model and the value of the vocabulary parameter from the client side, and it inspects if the translate text sentence express model, which corresponds to the primitive text sentence express model exists or not; If the result of the inspection showed a consistency between the primitive text sentence express model and the translate text sentence express model, the translating server inspects if the primitive text sentence express model is the non-parameter primitive text sentence express model or not; If the answer is yes, then the translating server automatically sends back the result of the translating to the client side and displays the result through the interface of the monitor. Otherwise, the translating server automatically evaluates if the inputting value of the vocabulary parameter matches the value of the translated vocabulary, which has been translated as the target language or not; If matched, the result of the translation is formed from the translate text sentence express model and the value of the translated vocabulary. The translating server automatically sends back the result of the translating to the client side and displays the result through the interface of the monitor.

For example, a lot of sentences are long and complicated in the commercial letter, which has many subordinate clauses, and the modify relations of the adverbial modifier and attributive modifier that need to be confirmed by the content of the commercial letter. Generally, the commercial letter is hardly translated by machine translation. However, it is usually feasible if we add some restrictions on the sentence of the commercial letter to limit the variety and complexity of the sentence. The restricted sentence can be the specific sentence express model for machine translation. The words and phrases in the specific sentence express model are also restrained according to their “commercial characteristic”; therefore, the ambiguous phenomenon of the meaning of the vocabulary can be dispelled.

The letter of the order has been used very commonly by the business and a lot of sentences have peculiar commercial expression ways. We illustrate the sentences, which used in the order letter frequently to explain the application of the model-parameter machine translation. For example, the sentence in Chinese is [symbol] [symbol] [symbol] [symbol] and corresponding this sentence is “Enclosed is our Indent No. 567 for 50 units of Star Brand Stereo Set B58” in English. This sentence can be set like [symbol] [symbol] [symbol] [symbol] as a primitive text sentence express model. Corresponding this primitive text sentence express model, the translate text sentence express model is “Enclosed is our Indent No. XX for XX units of XX Brand XX Set XX” at English.

By using the model-parameter machine translation, the translating server stores the information of the primitive text sentence express model and the translate text sentence express model and makes the primitive text sentence express model correspond with the translate text sentence express model. The corresponding translate text sentence express model is selected to be expressed as a translated result when the primitive text sentence express model is selected from the client side. As a prompt, the “XX” in the primitive text sentence express model represents the value of the vocabulary parameter, and it can be changed or replaced by user's request at the interface of the monitor. User can assign any value by a inputting or a selecting. The “XX” in the translate text sentence express model is the translated vocabulary that correspond with an inputting value of the vocabulary parameter of the primitive text sentence express model. The translated vocabulary in the translate text sentence express model is selected to be expressed as the translating result when the value of the vocabulary parameter in the primitive text sentence express model is confirmed and sent to the translating server by a user. After the translating process finished, the translating result is sent back to the client side and displayed as a translated full sentence on the computer terminal.

The primitive text sentence express model of [symbol] [symbol] [symbol] [symbol] can be set up as [symbol] [symbol] [symbol] [symbol] by user select or input the character(s) at “XX” prompts in the primitive text sentence express model, and the translated result will be “Enclosed is our Indent No. 123 for 200 units of Compaq Brand Computer Set A-5T”.

The primitive text sentence express model of [symbol] [symbol] [symbol] [symbol] also can be set up as [symbol] [symbol] [symbol] [symbol] [symbol] by user selects or inputs different character(s) at the “XX” prompts. The translated result will be “Enclosed is our Indent No. 419 for 500 units of Dockers Brand Jacket Set SDA-6”.

By the different value of the vocabulary parameter, one primitive text sentence express model can generate uncounted sentences, which have different business meanings by user requested. Therefore, there are uncounted sentences as the translating result. The primitive text sentence express models are multitudinous for a special meaning expression.

There are several primitive text sentence express models that are similar to above the primitive text sentence express model of [symbol] [symbol] [symbol] [symbol] (“Enclosed is our Indent No. XX for XX units of XX Brand XX Set XX”) for user's selection:

1. [symbol] [symbol] [symbol] [symbol] [symbol] (In the translate text sentence express model, it will be “We are pleased to enclose our official Order Sheet No. XX for your XX XX”.)

2. [symbol] [symbol] [symbol] [symbol] [symbol] [symbol] (In the translate text sentence express model, it will be “Thank you for your letter of XX XX enclosing your latest illustrated catalog. We would like to order XX units of Model XX shown on Page XX of the catalog”.)

3. [symbol] [symbol] [symbol] [symbol] [symbol] [symbol] (In the translate text sentence express model, it will be “We have tested your sample and found it very satisfactory. Please supply XX dozen as per our enclosed Order Form No. XX”.)

Users can use different values of the vocabulary parameter to generate different sentences for different business purposes by using different primitive text sentence express models, then, the translated sentences can be generated as a target language for their purpose. The above three primitive text sentence express models can generate three business sentences at original language like below:

1.

[symbol]

[symbol]

[symbol]

[symbol]

[symbol]

2.

[symbol]

[symbol]

[symbol]

[symbol]

[symbol]

[symbol]

3.

[symbol]

[symbol]

[symbol]

[symbol]

[symbol]

[symbol]

[symbol]

The three business sentences can be translated at target language like below:

1. We are pleased to enclose our official Order Sheet No. 30 for your Electric Refrigerator AB-100.

2. Thank you for your letter of September 10 enclosing your latest illustrated catalog. We would like to order 50 units of Model AZ10 shown on P 25 of the catalog.

3. We have tested your sample and found it very satisfactory. Please supply 500 dozen as per our enclosed Order Form No. 960.

FIG. 1 is a diagram of the model parameter machine translation, which corresponds to the client network translating server system; it depicts a pictorial representation of a network of the translation processing system in which the present invention may be implemented. In this diagram, model-parameter language translation system includes two client terminals (100 and 120). Each client terminal includes the browser (102 or 122), the TCP/IP suite of protocol (104 or 124). The browser (102 or 122) connects an Internet network (106 or 118) through the TCP/IP (104 or 124). Through an Internet address (108 or 116), the Internet server (110) receives the client's request and gathers up all of the information for running a CGI program (112). Once the CGI program (112) is running, it retrieves the details of the request from the request package that the Internet server (110) created and transmits the contents of the request package to the translating server (114). Then the translating server (114) performs its job, which executes the translating process and generates a response for the client's request and packages it through the CGI program (112) for the Internet server (110) that sends those responses back to the clients (100 and 120).

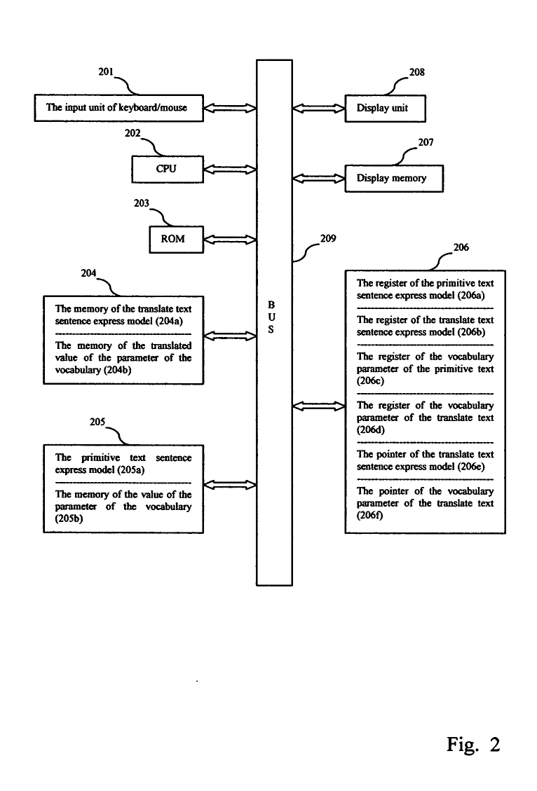

FIG. 2 is a diagram of the model-parameter machine translation system, which corresponds to stand-alone computer. The translating server is consisting of the Central Processing Unit (202), the input unit of keyboard/mouse (201), ROM (203), the display unit (208), functional memories (204-206) and BUS (209). The memory units include the display memory (207), the memory of the translate text (204), the memory of the primitive text (205) and the processing memory (206). The memory of the translate text (204) is consist of the memory of the translate text sentence express model (204a) and the memory of the translated value of the vocabulary parameter at a target language (204b). The memory of the primitive text (205) is consisting of the memory of the primitive text sentence express model (205a) and the memory of the value of the vocabulary parameter (205b) at an original language. The processing memory includes:
a) A register of the primitive text sentence express model (206a), which is used to hold the character string of the primitive text sentence express model from the memory of the primitive text sentence express model (205a);
b) A register of the translate text sentence express model (206b), which is used to hold the character string of the translate text sentence express model from the memory of the translate text sentence express model (204a).
c) A register of the vocabulary parameter of the primitive text (206c), which is used to hold the character string of the vocabulary parameter at an original language version.
d) A register of the vocabulary parameter of the translate text (206d), which is used to hold the character string of the vocabulary parameter at a target language version.
e) A pointer of the translate text sentence express model (206e), which is used to hold the data of the display position that is saved in the register of the translate text sentence express model (206b).
f) A pointer of the vocabulary parameter of the translate text (206f), which is used to hold the date of the display position that is saved in the register of the vocabulary parameter of the translated text (206d).

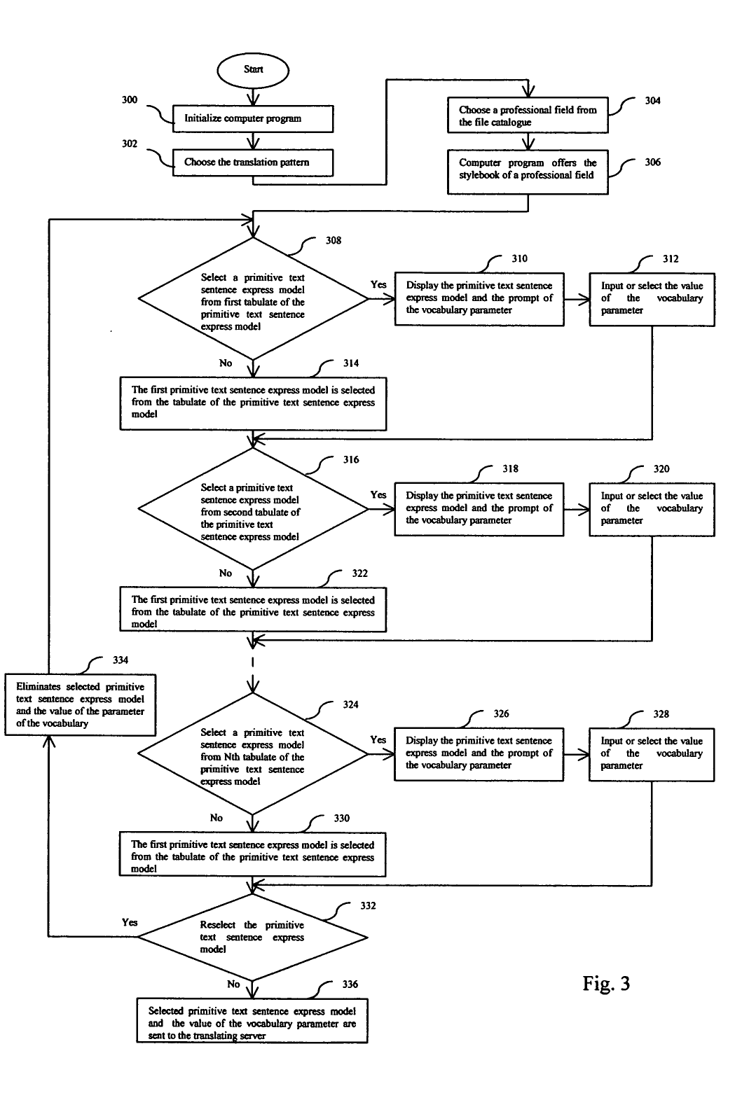

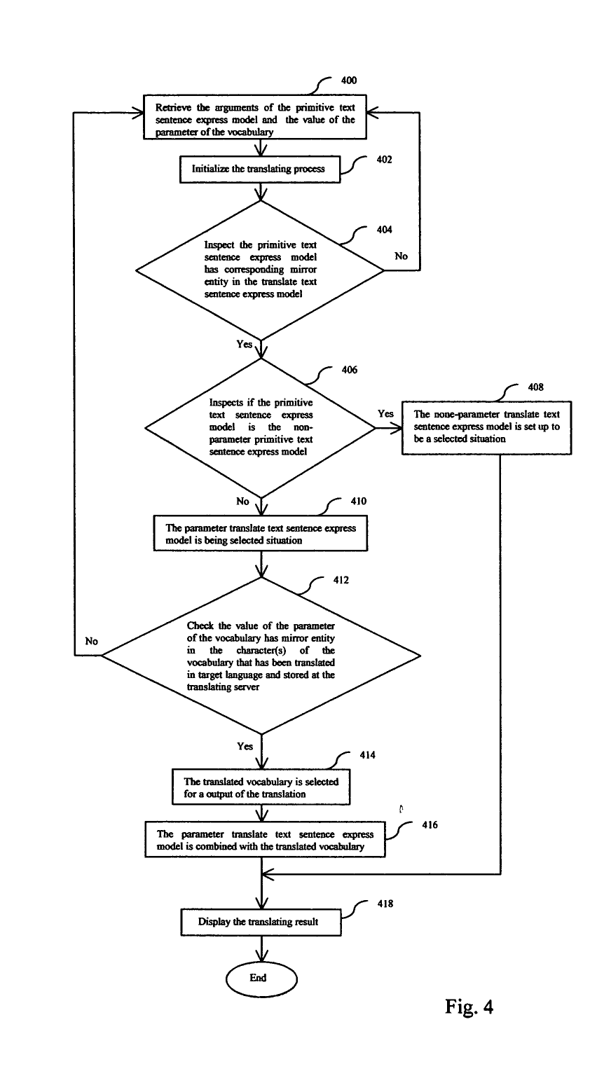

The translating process is in FIG. 3 and FIG. 4 for the stand-alone type translation.

FIG. 3 is the processing flow chart of the client side in the model-parameter machine translation system. The computer program is initialized to deal with the translating request from the user terminals (100, 122) in the step 300. In the step 302, the users can choose the pattern of the translation from one language to another language through the interface of the monitor by using the mouse or the keyboard. The translating pattern of Chinese to English is illustrated with simple pattern for convenience. However, there is no any limitation for any language translations by this execution example. In the step 304, the computer program automatically provides the specific and professional field catalogue on the interface of the monitor, for instance, the user can chooses the order letter from a list of business letter field, which include the contract, order, complain etc. The professional field catalogue consists of the title of the stylebooks, which are article for different purposes. The computer program automatically offers the Chinese version of the order letter's stylebook for user's using in the step 306. The steps 304-306 have set up the specific factors of the translation according to the model-parameter machine translation. The stylebook is consisting of more than one lists of the primitive text sentence express model. A list is consist of the primitive text sentence express models, which they have similar meaning for a specific semantic pattern. User can select a primitive text sentence express model from a list for what they need in the step 308. If one of the primitive text sentence express model is chosen from the list, the process proceeds into step 310 to display the primitive text sentence express model and the prompts of the vocabulary parameters, which are words in this primitive text sentence express model through the interface of the monitor. In the step 312, user can input or select the value of the vocabulary parameter at the prompt by using the mouse or keyboard. If the user have not selected the primitive text sentence express model from the list, the process proceeds into step 314, which the translating server automatically displays the first primitive text sentence express model from the list through the interface of the monitor. The first primitive text sentence express model is the non-parameter primitive text sentence express model. User judges every list of primitive text sentence express models in the stylebook with the steps of 308-314, which described above. If the user decide not to reselect the primitive text sentence express model from the list at step 332, the selected primitive text sentence express models and the values of the vocabulary parameters are sent to the translating server in step 336). Otherwise, the computer program eliminates selected primitive text sentence express model (step 334) and gets back to step 308 for the reselection of the primitive text sentence express model from the list of the primitive text sentence express model.

FIG. 4 is the processing flow chart of the translating server (104) in the model-parameter machine translation system. After retrieving the arguments of the primitive text sentence express models and the values of the vocabulary parameters from the client side, the translating program is initialized and enabled to deal with the request for translation from the user in step 402. The translating server inspects if the primitive text sentence express model matches the translate text sentence express model or not (step 404). If the inspection showed a consistency between the primitive text sentence express model and the translate text sentence express model, the process proceeds into step 406. Otherwise, the process gets back to step 400. In step 406, the translating server inspects if the primitive text sentence express model is a non-parameter primitive text sentence express model or not; if the primitive text sentence express model is a non-parameter primitive text sentence express model, the non-parameter translate text sentence express model is set up to a selected situation (408); The translating server outputs the translating result through the interface of the monitor (418). Otherwise, the parameter translate text sentence express model is in a selected situation (410). The translating server evaluates if the inputted value of the vocabulary parameter that is embedded in the primitive text sentence express model matches the value of the translated vocabulary, which has been translated in a target language or not; If matched, the translated vocabulary is selected for an output of the translation (414). Otherwise, the process gets back to step 400. The result of the translation is formed from the translate text sentence express model and the value of the translated vocabulary (418).

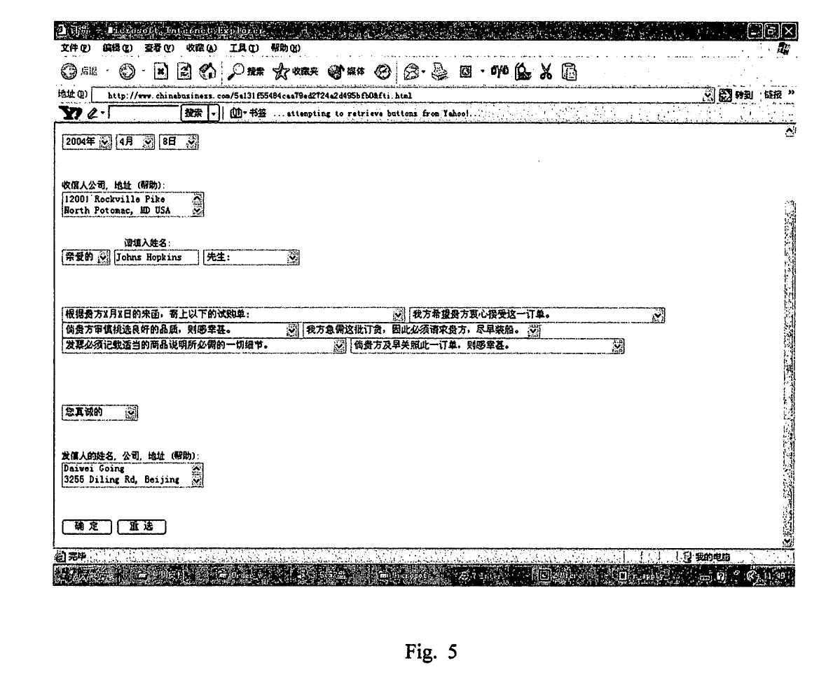

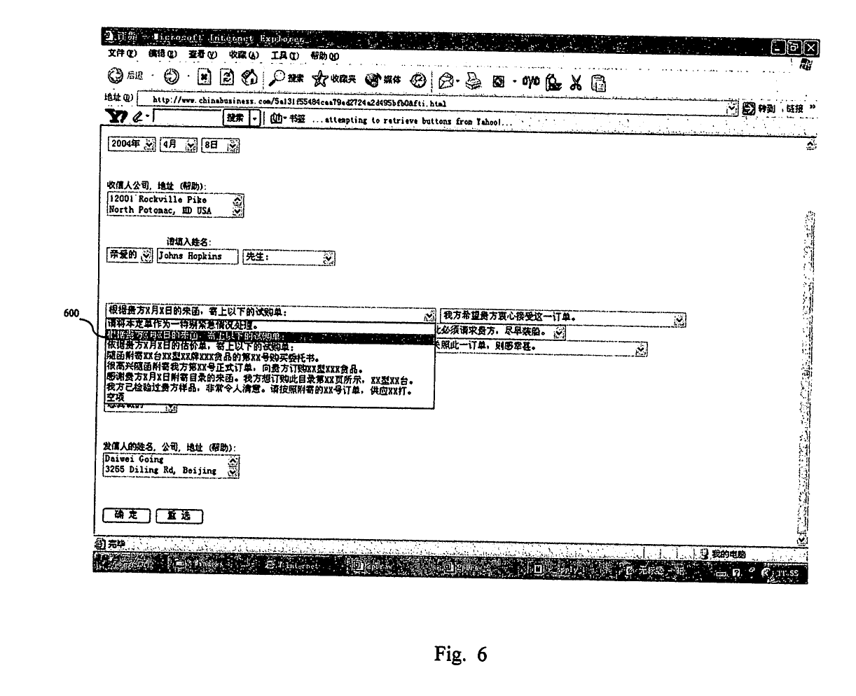

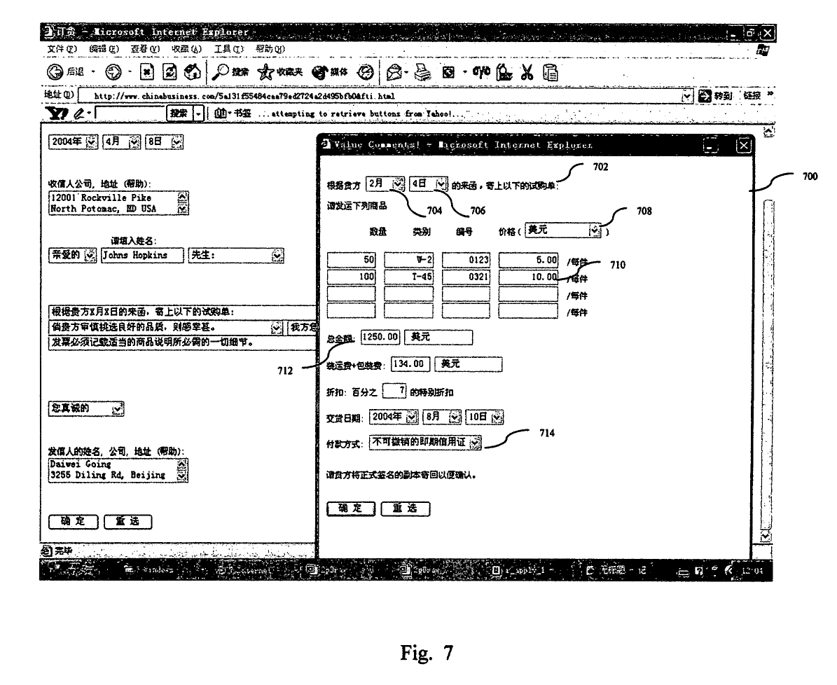

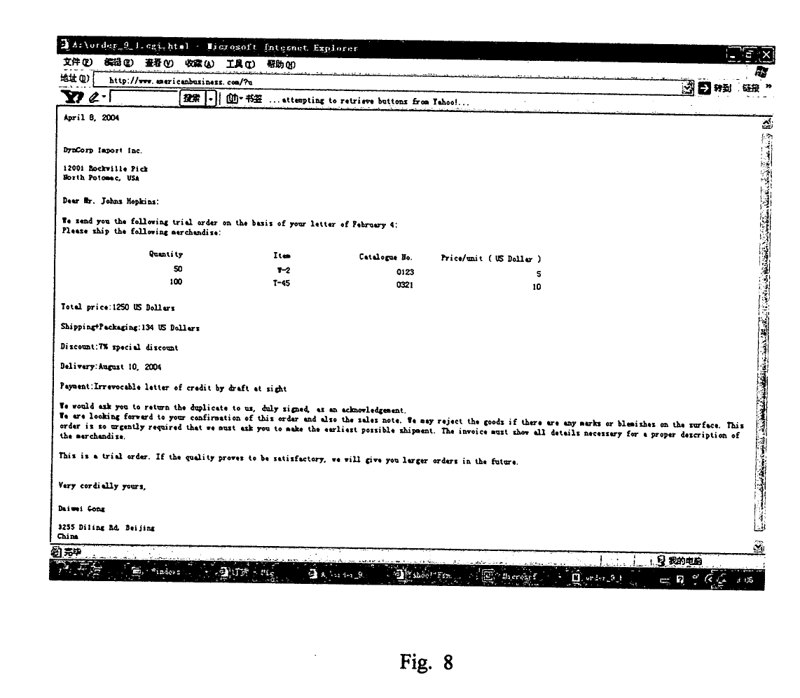

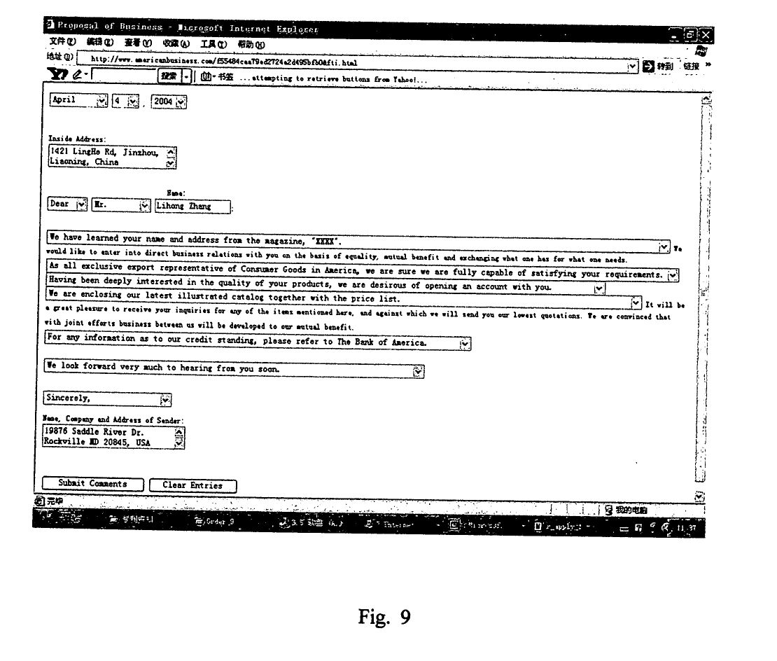

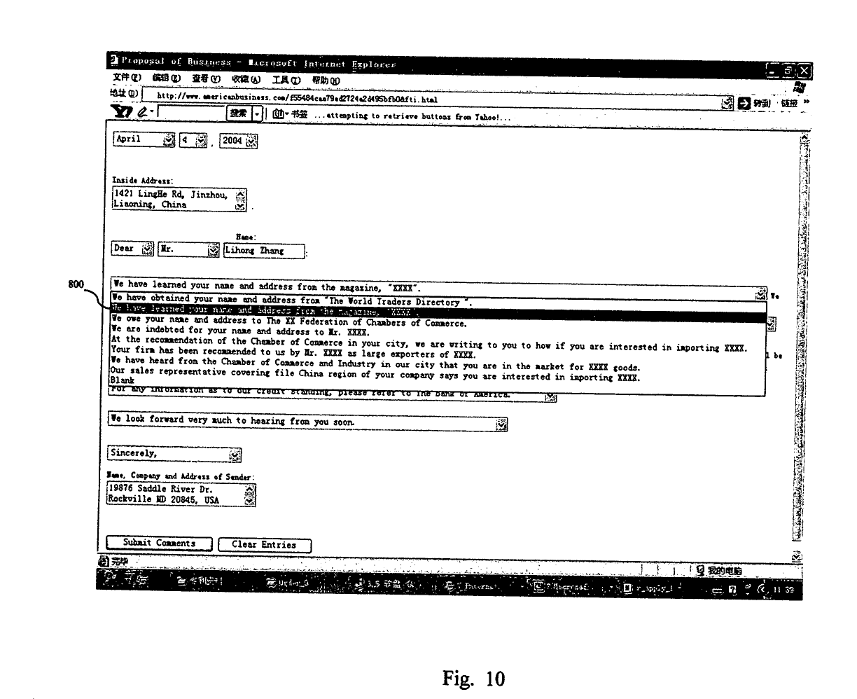

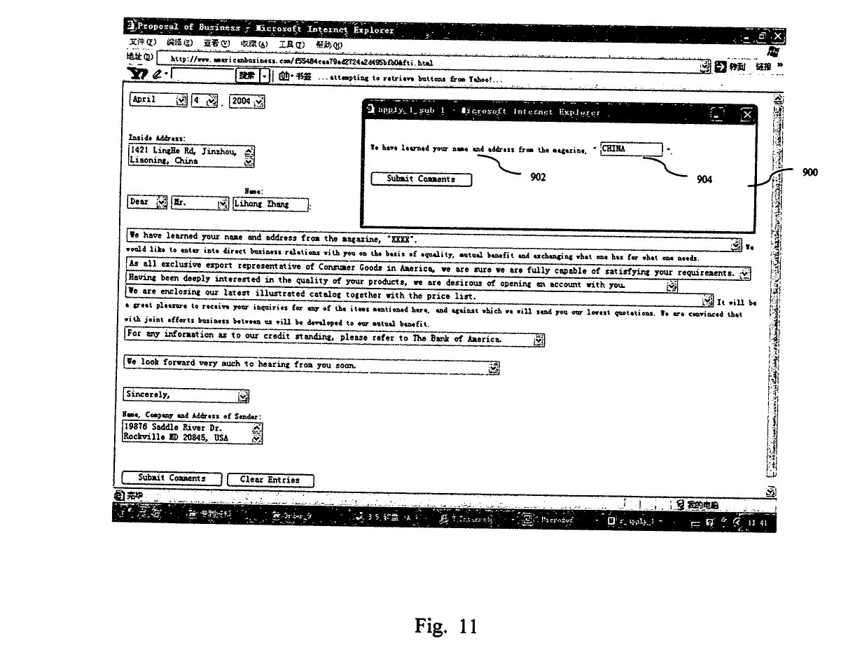

FIG. 5-FIG. 12 are the screenshots of the user interface and the result of the translation processing system to show how the model-parameter machine translation system is utilized. In a translating pattern of Chinese->English, FIG. 5 shows a user interface of the order letter in Chinese. FIG. 6 shows that a primitive text sentence express model (600) is selected from the first list of the primitive text sentence express model in the stylebook of the order letter by user. Because user's selection, the computer program generates a sub-window (700), which it includes the primitive text sentence express model (702) and the prompts of the vocabulary parameters (704-712), in FIG. 7. User can select the values of the vocabulary parameters (704-708, 714) or input the values of the vocabulary parameters (710-712) at the prompts. The sub-window returns the main window (FIG. 6) after the user clicks the button of [symbol] (“Submit”), or the values of the vocabulary parameters can be reset by user clicks the button of [symbol] (“Reset”). In FIG. 6, the user can push the button of [symbol] (“Submit”) when all of lists of the primitive text sentence express model and the value of the vocabulary parameter are selected or inputted. As a translated result, the order letter at English displays on interface of computer terminal (802) in FIG. 8. In the translating pattern of English->Chinese, FIG. 9 shows a user interface of a proposal business letter in English. FIG. 10 shows a primitive text sentence express model (800) that is selected from the first list of the primitive text sentence express model in the stylebook of the proposal business letter by user. Because user's selection, the computer program generates a sub-window (900), which it includes the primitive text sentence express model (902) and the prompts of the vocabulary parameters (904). In FIG. 11 user can input the value of the vocabulary parameter (904) at the prompt. The sub-window returns the main window (FIG. 10) after the user clicks the button of “Submit Comments”.

1. A model-parameter machine translation method for translating a first text in an original language to a second text in a target language, the method comprising the steps of:
a) By using the specific fields, the specific occasions, the specific purposes, the specific applications and the specific conditions to establish from a natural language the specific factors of machine translation. According to the specific factors, at least two kinds of specific models is set up for a specific semantic sentence of a natural language.
b) The primitive text sentence express model is an express pattern of the sentence that is made up from the special fields, the special occasions, the special purposes, the special applications and the special conditions at an original language. A translate text sentence express model is a translated sentence express pattern, which corresponds to the primitive text sentence express model at target language. Both the primitive text sentence express model and the translate text sentence express model are stored in the translating server, which is a translating engine to perform the translation processing.
c) User chooses the primitive text sentence express model from the translating server through the mouse or the keyboard according to user's needs. Either in the primitive text sentence express model or in the translate text sentence express model, every word can be changed as a unit by a translating process's needs. User chooses the parameters of the vocabulary by using the mouse or the keyboard from primitive text sentence express model that was chosen. User can change the value of the vocabulary parameter in order to avoid the ambiguous emergence at the meaning of the vocabulary.
d) The translating server integrates the translate text sentence express model that corresponded with the selected primitive text sentence express model and the value of the vocabulary that has been translated at the translating server according to the input of vocabulary parameter at the primitive text sentence express model to processes the translation. The monitor will express the translating result of the translating server.

2. The method of claim 1, wherein the sentence which corresponds to one kind of semantic meaning at a natural language can be expressed from more than one kind of the primitive text sentence express model for user's selection.

3. The method of claim 1, wherein user can choose the primitive text sentence express model and input or select the value of the parameter of the vocabularies from the primitive text sentence express model by using the mouse or the keyboard according to user's needs.

4. The method of claim 1, wherein when the vocabulary parameter is selected, the translating server automatically checks on the grammar rule of the vocabulary parameter to make sure the grammar expression of the vocabulary is consistent with the grammar rule in the primitive text sentence express model. If the translating server finds an inconsistency between the vocabulary parameter and the primitive text sentence express model, it automatically revises the inconsistent part at the vocabulary parameter base on the grammar expression of the primitive text sentence express model to make both parts to be unanimous.

5. The method of claim 1, wherein When the translated vocabularies are multiple, the translating server checks the grammar and revises the inconsistent one with the grammar rule from the far left vocabulary to last one in the translate text sentence express model.

6. The method of claim 1, wherein user can choose the pattern of the translation from one language to another language through the interface of the monitor by using the mouse or the keyboard.

7. The method of claim 1, wherein a language at an original language can be any language and a translated language at a target language also can be any language that is different with the original language.

8. The method of claim 1, wherein the interface of the monitor automatically provides the professional field catalogue. The professional field catalogue consists of the title of the stylebooks, which are articles for different purpose's using. One title of the stylebooks can be chosen from the professional field catalogue for translation by user's selection. When one of the titles of the stylebooks is selected, the translating server automatically displays the content of that stylebook.

9. The method of claim 1, wherein the stylebook consists of more than one lists of the primitive text sentence express model. The list of the primitive text sentence express model consist of the primitive text sentence express models, where they have similar meaning for a specific semantic sentence. Users can select the primitive text sentence express model from the list of what they need. If a primitive text sentence express model is chosen from the list, the translating server will automatically displays the primitive text sentence express model and the prompt(s) of the vocabulary parameter(s) through the interface of the monitor. User can input or select the value of the vocabulary parameter at the prompt by using the mouse or keyboard. If users do not choose the primitive text sentence express model from the list, the translating server automatically displays the first primitive text sentence express model from the list through the interface of the monitor. The first primitive text sentence express model always is the non-parameter primitive text sentence express model. The selected primitive text sentence express model and the inputted and selected value of the vocabulary parameter are sent to the translating server.

10. The method of claim 1, wherein the translating server receives the information from the primitive text sentence express model and the value of the vocabulary parameter from the client side, and inspects if the translate text sentence express model, which corresponds to the primitive text sentence express model, exists or not; If the result of the inspection showed a consistency between the primitive text sentence express model and the translate text sentence express model, the translating server inspects if the primitive text sentence express model is the non-parameter primitive text sentence express model or not; If the answer is yes, then the translating server automatically sends back the result of the translating to the client side and displays the result through the interface of the monitor. Otherwise, the translating server automatically evaluates if the inputting value of the vocabulary parameter matches the value of the translated vocabulary, which has been translated as the target language or not; If matched, the result of the translation is formed from the translate text sentence express model and the value of the translated vocabulary. The translating server automatically sends back the result of the translating to the client side and displays the result through the interface of the monitor

11. The method of claim 1, wherein the frame of a client-network-translating server is used. The inputting request of a language translation is processed on the client side, and the translating processes are handled at the translating server. The input and output of the language translation between two languages are communicated through the network system between the client and the translating server. By the client's request, the translating server can send the translating result to one or more than one clients.

12. The method of claim 6, wherein the meaning of the network include Internet, WAN, LAN, telephone wire network, optical cable network, wireless network and the combinations of those networks.

13. The method of claim 1, wherein the translating server include the central processing unit, memory, display utilities, keyboard and mouse.

14. The method of claim 1, wherein the memories are divided into the display utility memory, the translate text sentence express model's memory, the primitive text sentence express model's memory and processing memory.

15. The method of claim 1, wherein this translation system can be used in any character materials that includes book, magazine, newspapers, advertisement, television, movie, letter, telegram, fax, manual, contract, agreement, official document, official letter, certificate.
